(19) United States
(12) Patent Application Publication
(10) Pub. No.: US 2015/0255878 A1
(43) Pub. Date: Sep. 10, 2015

(54) Broadband Antenna

(71) Applicant: Wistron NeWeb Corporation, Hsinchu (TW)

(72) Inventor: Chieh-Sheng Hsu, Hsinchu (TW)

(21) Appl. No.: 14/481,907

(22) Filed: Sep. 9, 2014

(30) Foreign Application Priority Data
Mar. 7, 2014 (TW) 103107912

(51) Int. Cl. H01Q 19/10; H01Q 19/185

(52) U.S. Cl. CPC H01Q 19/10; H01Q 19/185

(57) ABSTRACT

A broadband antenna configured to receive and transmit at least one wireless signal includes a first metal radiation portion having a first triangular metal plate and a second triangular metal plate; a metal reflective module, having a plurality of metal reflective elements, wherein the plurality of metal reflective elements are able to be assembled to make the metal reflective module a shape substantially conforming to a cavity structure and to surround the first metal radiation portion, and the metal reflective module is configured to reflect the at least one wireless signal and to enhance gain of the broadband antenna; and a supporting element, configured to fix the first triangular metal plate in opposition to the second triangular metal plate, to attach the first metal radiation portion to the cavity structure of the metal reflective module, and to electrically isolate the metal reflective module from the first metal radiation portion.

### BACKGROUND OF THE INVENTION

1. Field of the Invention

The present invention relates to a broadband antenna, and more particularly, a broadband antenna providing high gain, wide operating frequency bandwidth and convenience of storage and transportation.

2. Description of the Prior Art

Electronic products with wireless communication functionalities utilize antennas to emit or receive radio waves, to transmit or exchange radio signals, so as to access a wireless communication network. Therefore, to facilitate a user's access to the wireless communication network, an ideal antenna should maximize both its operating frequency bandwidth and gain.

In order to increase the gain, the prior art has already provided a variety of additional structures to enhance reflectivity of an antenna; nevertheless, physical dimensions of the antenna will also grow, such that the antenna costs become more and inconveniences increase during installation. Consequently, it is a common goal in the industry to design a broadband antenna with a simple structure to reduce the manufacture and transportation cost.

### SUMMARY OF THE INVENTION

It is therefore one of the objectives of the present invention to provide a broadband antenna, which ensures high gain, wide operating frequency bandwidth and convenience of storage or transportation.

An embodiment of the invention provides a broadband antenna, configured to receive and transmit at least one wireless signal, comprising a first metal radiation portion, comprising a first triangular metal plate and a second triangular metal plate; a metal reflective module, comprising a plurality of metal reflective elements, wherein the plurality of metal reflective elements are able to be assembled to make the metal reflective module a shape substantially conforming to a cavity structure and to surround the first metal radiation portion, and the metal reflective module is configured to reflect the at least one wireless signal and to enhance gain of the broadband antenna; and a supporting element, configured to fix the first triangular metal plate in opposition to the second triangular metal plate, to attach the first metal radiation portion within the cavity structure of the metal reflective module, and to electrically isolate the metal reflective module from the first metal radiation portion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating an exploded view of a broadband antenna according to an embodiment of the present invention.

FIG. 1B is a schematic diagram illustrating a perspective view of the broadband antenna shown in FIG. 1A after assembly.

FIG. 1C is a schematic diagram illustrating a top view of the broadband antenna shown in FIG. 1A after assembly.

FIG. 1D is a cross-sectional view diagram taken along a cross-sectional line A-A′ in FIG. 1C.

FIG. 1E is a schematic diagram illustrating antenna resonance simulation results of the assembled broadband antenna shown in FIG. 1A.

FIG. 2A is a schematic diagram illustrating an exploded view of a broadband antenna according to an embodiment of the present invention.

FIG. 2B is a schematic diagram illustrating a perspective view of the broadband antenna shown in FIG. 2A after assembly.

FIG. 2C is a schematic diagram illustrating antenna resonance simulation results of the broadband antenna shown in FIG. 2A.

FIG. 3A is a schematic diagram illustrating an exploded view of a broadband antenna according to an embodiment of the present invention.

FIG. 3B is a schematic diagram illustrating a perspective view of the broadband antenna shown in FIG. 3A after assembly.

FIG. 3C is a schematic diagram illustrating antenna resonance simulation results of the broadband antenna shown in FIG. 3A.

FIG. 4A is a schematic diagram illustrating a perspective view of the broadband antenna 40 after assembly according to an embodiment of the present invention.

FIG. 4B is a schematic diagram illustrating antenna resonance simulation results of the broadband antenna shown in FIG. 4A.

FIG. 4C is a schematic diagram illustrating antenna radiation gain pattern versus space angle relationship for the broadband antenna shown in FIG. 4A operated at 500 MHz.

FIG. 4D is a schematic diagram illustrating antenna radiation gain pattern versus space angle relationship for the broadband antenna shown in FIG. 4A operated at 800 MHz.

FIG. 5 is a schematic diagram illustrating a locally enlarged view of a broadband antenna according to an embodiment of the present invention.

FIG. 6 is a schematic diagram illustrating a locally enlarged view of a broadband antenna according to an embodiment of the present invention.

FIG. 7 is a schematic diagram illustrating a locally enlarged view of a broadband antenna according to an embodiment of the present invention.

FIG. 8 is a schematic diagram illustrating a locally enlarged view of a broadband antenna according to an embodiment of the present invention.

FIG. 9 is a schematic diagram illustrating a broadband antenna according to an embodiment of the present invention.

### DETAILED DESCRIPTION

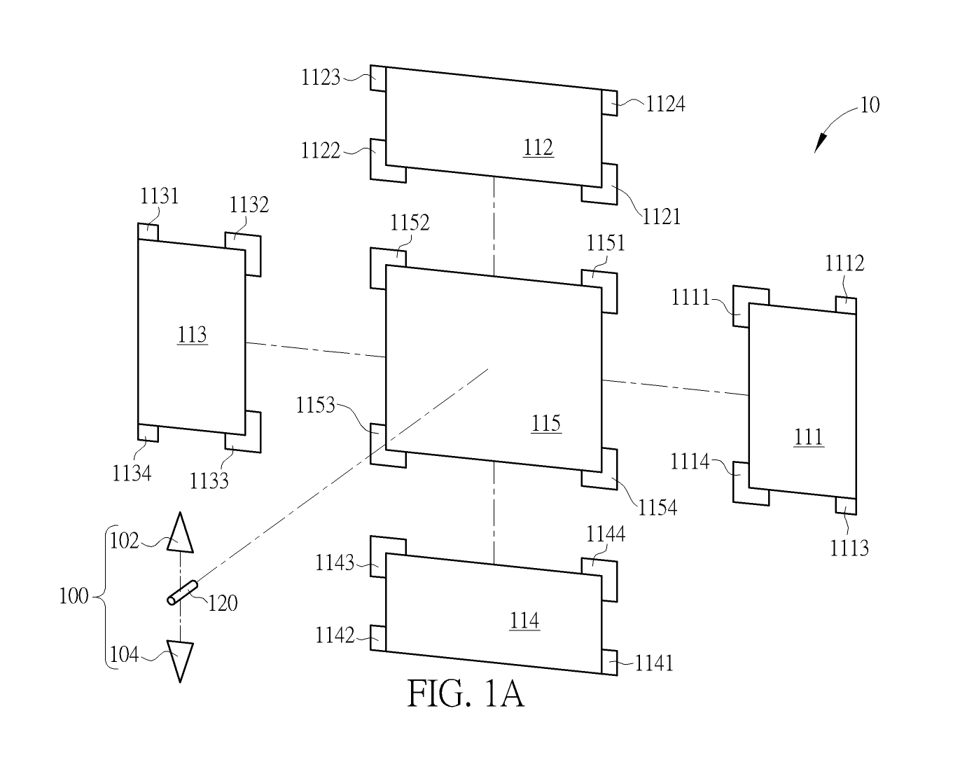

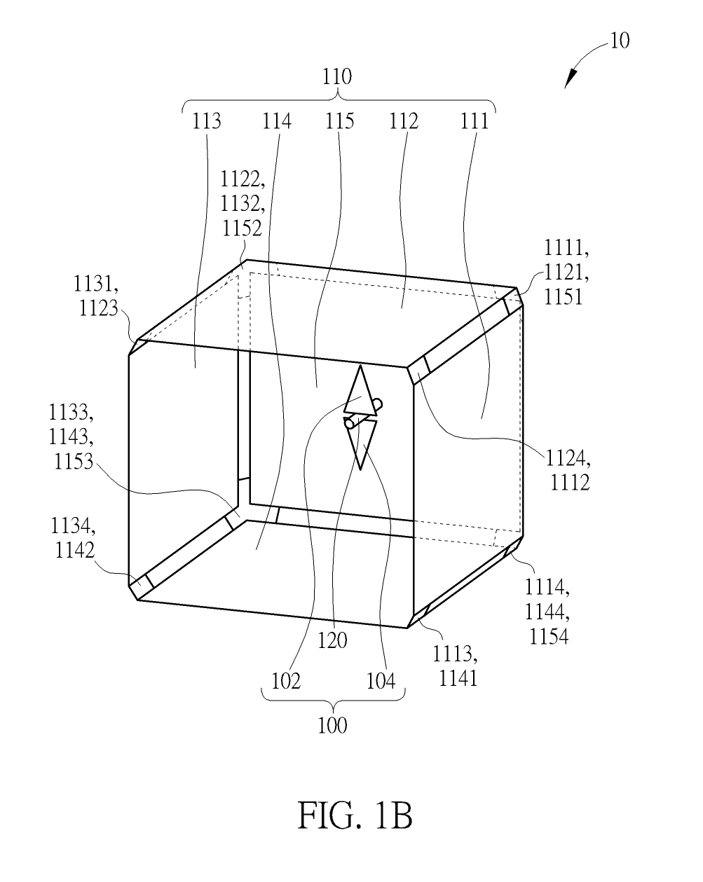

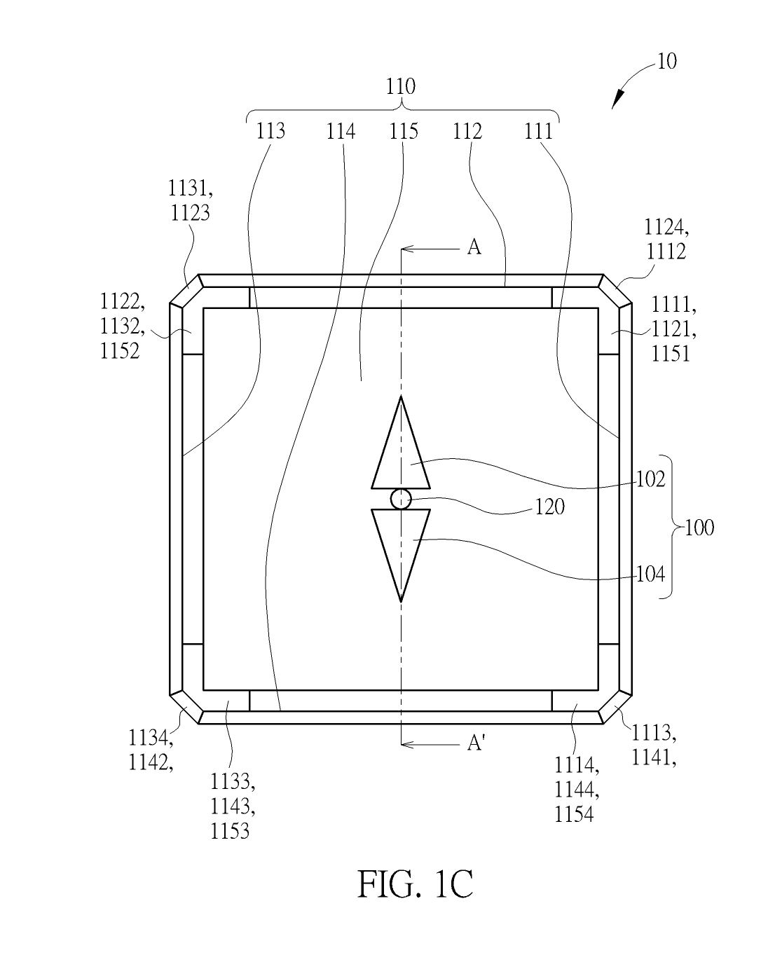

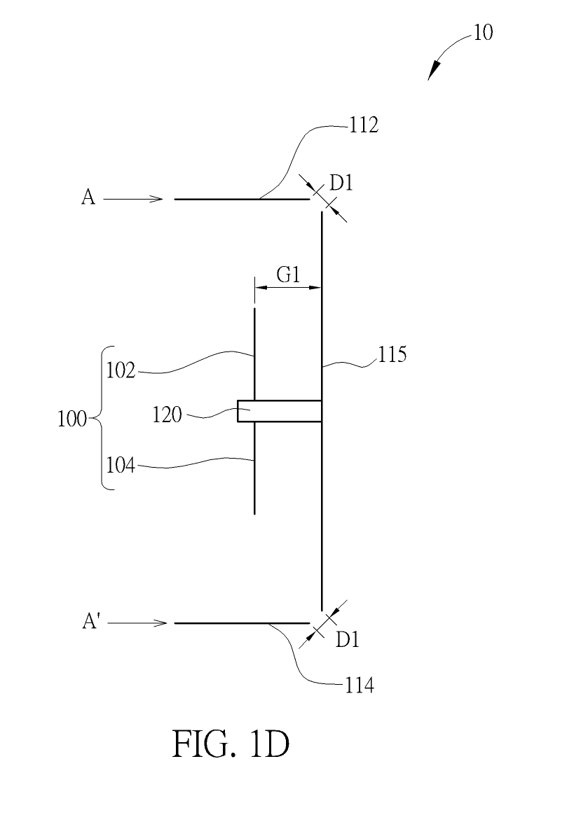

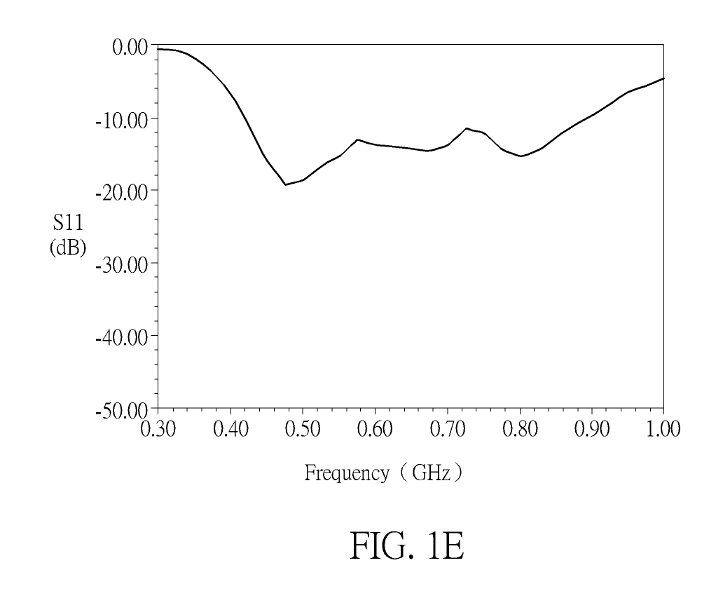

Please refer to FIGS. 1A-1D. FIG. 1A is a schematic diagram illustrating an exploded view of a broadband antenna 10 according to an embodiment of the present invention. FIG. 1B is a schematic diagram illustrating a perspective view of the broadband antenna 10 after assembly. FIG. 1C is a schematic diagram illustrating a top view of the broadband antenna 10 after assembly. FIG. 1D is a cross-sectional view diagram taken along a cross-sectional line A-A′ in FIG. 1C. As shown in FIG. 1A, the broadband antenna 10 comprises a metal radiation portion 100, a metal reflective module 110 and a supporting element 120. The metal radiation portion 100 comprises triangular metal plates 102 and 104. In this embodiment, the triangular metal plates 102 and 104 are isosceles triangular metal plates, but not limited thereto. A central conductor of a transmission line for feeding the broadband antenna 10 can be connected to a triangular metal plate of the metal radiation portion 100 (e.g., the triangular metal plate 102), while a mesh conductor of the transmission line can be connected to another triangular metal plate of the metal radiation portion 100 (e.g., the triangular metal plate 104). The central conductor can be electrically connected to the metal reflective module 110, but not limited thereto. The supporting element 120 is utilized to fix the triangular metal plates 102 and 104 positioned relative to each other, such that the base of the triangular metal plate 102 is parallel to the base of the triangular metal plate 104, forming the metal radiation portion 100 into a rhombus. The supporting element 120 makes the metal radiation portion 100 fixed in a cavity of the assembled metal reflective module 110, and the supporting element 120 separates the metal reflective module 110 from the metal radiation portion 100 by a gap G1 so that the metal reflective module 110 and the metal radiation portion 100 are electrically isolated as shown in FIG. 1D

Specifically, the metal reflective module 110 comprises metal reflective elements 111, 112, 113, 114, and 115. The metal reflective elements 111, 112, 113 and 114 have a shape substantially conforming to a rectangle, and an assembly element is provided around each of the four vertices marked as 1111-1114, 1121-1124, 1131-1134, and 1141-1144 respectively. The metal reflective element 115 has a shape substantially conforming to a square, and an assembly element is provided around each of the four vertices, marked as 1151-1154. As shown in FIGS. 1A and 1B, when the metal reflective elements 111-115 are completely assembled, the adjacent vertices of the assembly elements correspond to each other—that is to say, the assembly element 1111 corresponds to the assembly elements 1121 and 1151, by the same token the assembly element 1112 corresponds to the assembly element 1124, and so forth. As a result, by means of fixing the assembly element 1111 to the assembly elements 1121 and 1151, fixing the assembly element 1112 to the assembly element 1124, fixing the assembly element 1122 to the assembly elements 1132 and 1152, fixing the assembly element 1123 to the assembly element 1131, fixing the assembly element 1133 to the assembly elements 1143 and 1153, fixing the assembly element 1134 to the assembly element 1142, fixing the assembly element 1144 to the assembly elements 1114 and 1154, fixing the assembly element 1141 to the assembly element 1113, the metal reflective elements 111-115 are electrically connected one another, and hence the metal radiation portion 100 is surrounded by the metal reflective module 110. In other words, the metal reflective elements 111-115 form a cavity with the assembly elements 1111-1154 to reflect wireless signals from or toward the metal radiation portion 100, and to enhance gain of the broadband antenna 10. It is worth noting that each two adjacent metal reflective elements 111-115 shown in FIGS. 1B-1D are separated by a distance D1, and the distance D1 can be 0 to enhance reflection effect. Simultaneously, since the metal radiation portion 100 and the metal reflective elements 111-115 of the metal reflective module 110 substantially have a plate-like structure, it is simple to manufacture and convenient for storage and transportation after dismantled. Please note that the assembly elements 1111-1154 are exemplary embodiments of the present invention, but the present invention is not limited thereto and the number of the assembly elements can be adjusted according to different design requirements. For example, only the assembly elements 1111, 1113 and 1114 are disposed respectively around three vertices of the metal reflective element 111, and the assembly element 1124 of the metal reflective element 112 is fixed to the last vertex of the metal reflective element 111 without an assembly element. Alternatively, apart from the assembly elements 1111-1114, the metal reflective element 111 further comprises other assembly elements in order to enhance the connection among the metal reflective element 111 and the metal reflective elements 112, 114 and 115.

Briefly, the embodiment of the present invention receives and transmits wireless signals through the metal radiation portion 100. The triangular shape of the triangular metal plates 102 and 104 provides wider bandwidth, and the cavity structure of the metal reflective module 110 surrounding the metal radiation portion 100 effectively benefits reflection of wireless signals, thereby enhancing the gain of the broadband antenna 10. The metal reflective module 110 substantially comprises the metal reflective elements 111-115 which are flat-structured ones. Therefore, it is simple to manufacture and convenient for storage and transportation after disassembled.

Simulation and measurement may be employed to determine whether the broadband antenna 10 meets system requirements. For example, FIG. 1E is a schematic diagram illustrating antenna resonance simulation results of the assembled broadband antenna 10, wherein length and width of the assembled broadband antenna 10 are both set to be 500 mm, height is set to be 163 mm, and distance D1 between the metal reflective elements 111-115 is set to be 0.5 mm. As can be seen from FIG. 1E, the resonance bandwidth of the broadband antenna 10 covers ultra high frequency (UHF) band by using −10 dB as a threshold. On the other hand, Table 1 is an antenna characteristic table for the broadband antenna 10. According to Table 1, the broadband antenna 10 has a high directivity.

TABLE 1

| | | 3 dB | | common polarization |
|---|---|---|---|---|
| | maximum | beam- | front-to-back | to cross polarization |
| frequency | gain | width | (F/B) ratio | (Co/Cx) ratio |
| 470 MHz | 8.7 dBi | 72 deg | 25.6 dB | 48.5 dB |
| 500 MHz | 9.0 dBi | 70 deg | 27.5 dB | 44.7 dB |
| 600 MHz | 10.0 dBi | 60 deg | 42.3 dB | 45.5 dB |
| 700 MHz | 11.4 dBi | 49 deg | 18.3 dB | 47.6 dB |
| 800 MHz | 11.4 dBi | 43 deg | 20.3 dB | 51.5 dB |
| 862 MHz | 12.0 dBi | 38 deg | 23.6 dB | 36.6 dB |

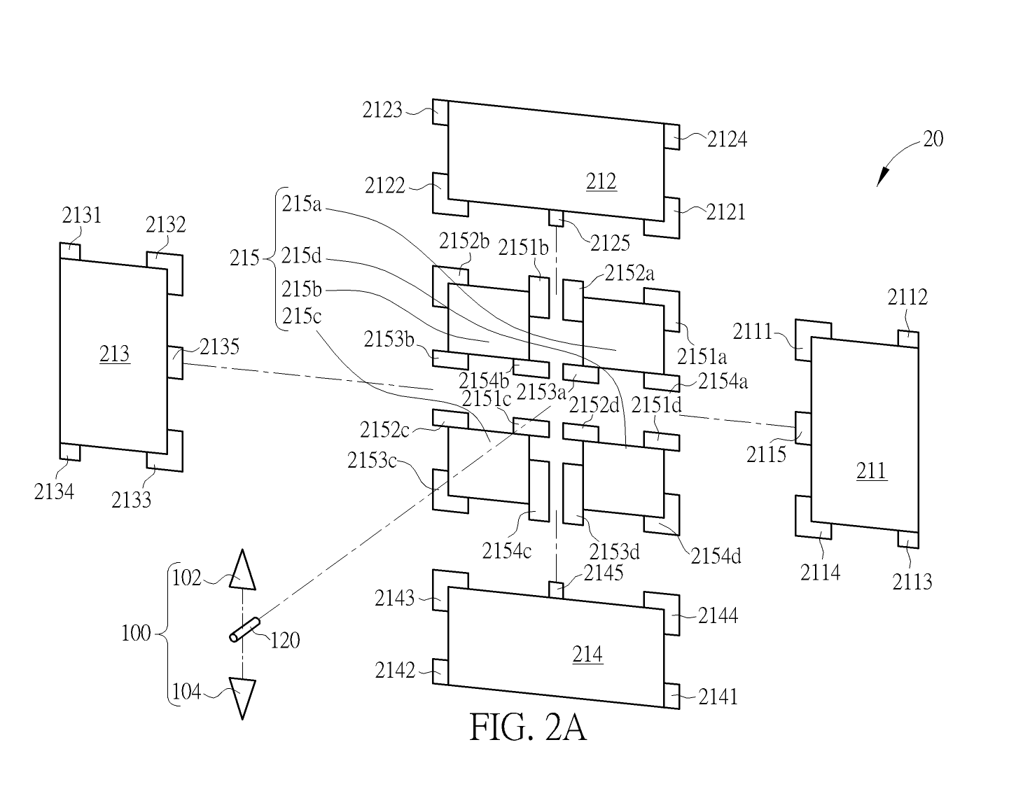

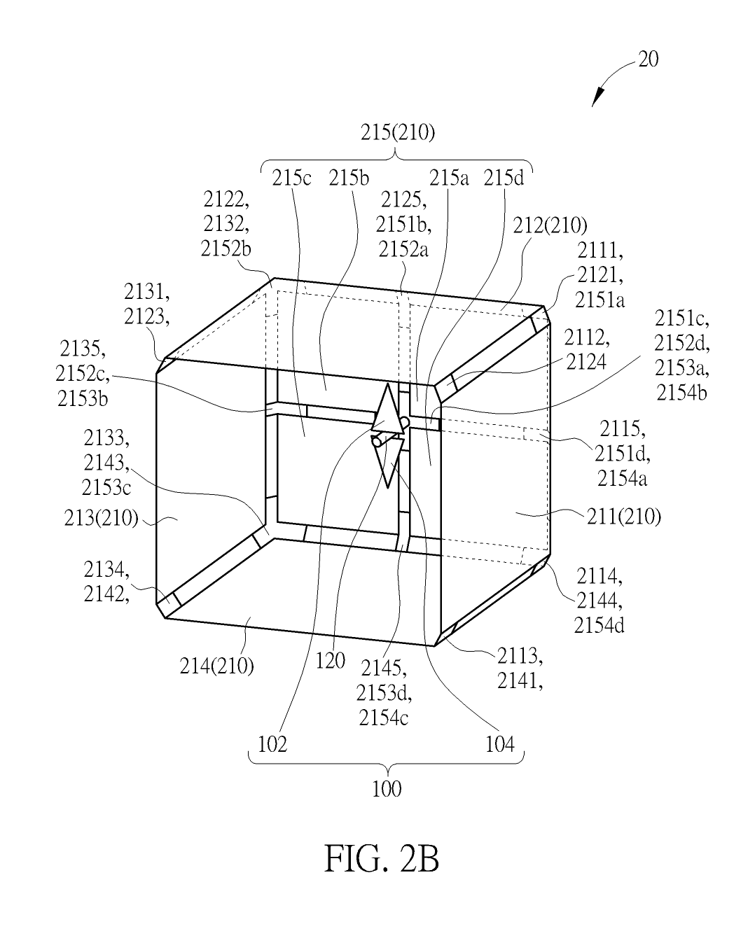

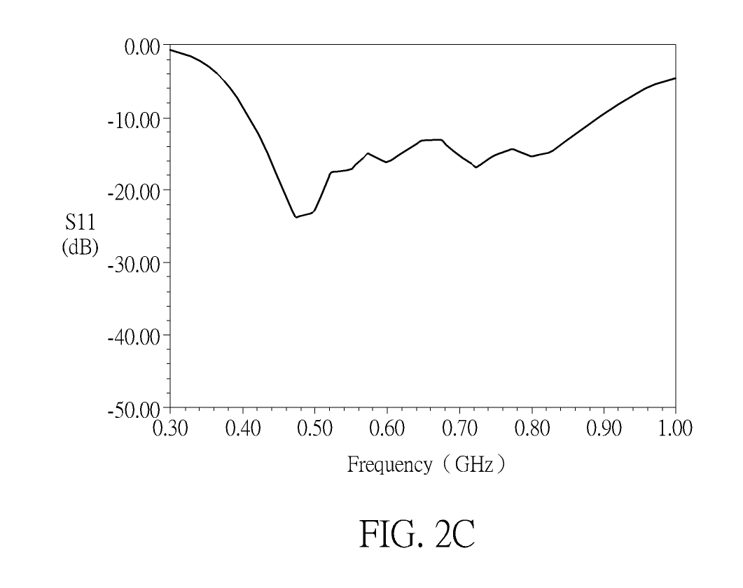

In order to further reduce the maximum area, length and width of single plate of the disassembled broadband antenna 10, please refer to FIGS. 2A-2C. FIG. 2A is a schematic diagram illustrating an exploded view of a broadband antenna 20 according to an embodiment of the present invention. FIG. 2B is a schematic diagram illustrating a perspective view of the broadband antenna 20 after assembly. As shown in FIG. 2A, structures of the broadband antenna 20 and the broadband antenna 10 are substantially similar. However, unlike the broadband antenna 10, a metal reflective element 215 of a metal reflective module 210 of the broadband antenna 20 comprises metal reflective plates 215a-215d. Moreover, the metal reflective plates 215a-215d can be assembled to form the metal reflective element 215 by fixing assembly elements 2151c, 2152d, 2153a and 2154b of the metal reflective plates 215a-215d together, by fixing assembly elements 2152a and 2154a of the metal reflective plate 215a respectively to an assembly element 2151b of the metal reflective plate 215b and an assembly element 2151d of the metal reflective plate 215d, and by fixing assembly elements 2152c and 2154c of the metal reflective plate 215c to an assembly element 2153b of the metal reflective plate 215b and an assembly element 2153d of the metal reflective plate 215d. Besides, assembly elements 2151a, 2154a, 2151d and 2154d of the metal reflective element 215 can be fixed to assembly elements 2111, 2115 and 2114 of the metal reflective element 211; assembly elements 2151a, 2152a, 2151b and 2152b can be fixed to assembly elements 2121, 2125 and 2122 of the metal reflective element 212; assembly elements 2152b, 2153b, 2152c and 2153c can be fixed to assembly elements 2132, 2135 and 2133 of the metal reflective element 213; assembly elements 2153c, 2154c, 2153d and 2154d can be fixed to assembly elements 2143, 2145 and 2144 of the metal reflective element 214. FIG. 2C is a schematic diagram illustrating antenna resonance simulation results of the broadband antenna 20, wherein length and width of the broadband antenna 20 are set to be 500 mm, height is set to be 163 mm; the distance D1 between the metal reflective elements 211-214 and the metal reflective plates 215a-215d is set to be 0.5 mm. As can be seen from FIG. 2C, the resonance bandwidth of the broadband antenna 20 covers ultra high frequency by using −10 dB as a threshold. On the other hand, Table 2 is an antenna characteristic table for of the broadband antenna 20. According to Table 2, the broadband antenna 20 has a high directivity. Furthermore, since the metal reflective element 215 is formed from four smaller metal reflective plates assembled together, the maximum area, length and width of one single dismantled metal reflective plate can be minimized to facilitate storage and transportation. Please note that the metal reflective element 215 may be formed from two or more pieces of metal reflective plates to make storage and transportation easier.

TABLE 2

| | | | 3 dB | | common polarization |
|---|---|---|---|---|---|
| | maximum | | beam- | front-to-back | to cross polarization |
| frequency | gain | | width | ratio | ratio |
| 470 MHz | 8.7 | dBi | 7l deg | 17.2 dB | 31.3 dB |
| 500 MHz | 9.l | dBi | 68 deg | 16.4 dB | 25.8 dB |
| 600 MHz | 9.l | dBi | 59 deg | 10.1 dB | 17.3 dB |
| 700 MHz | 10.7 | dBi | 53 deg | 15.5 dB | 28.7 dB |
| 800 MHz | 11.4 | dBi | 43 deg | 14.6 dB | 42.6 dB |
| 862 MHz | 12.2 | dBi | 38 deg | 19.4 dB | 44.3 dB |

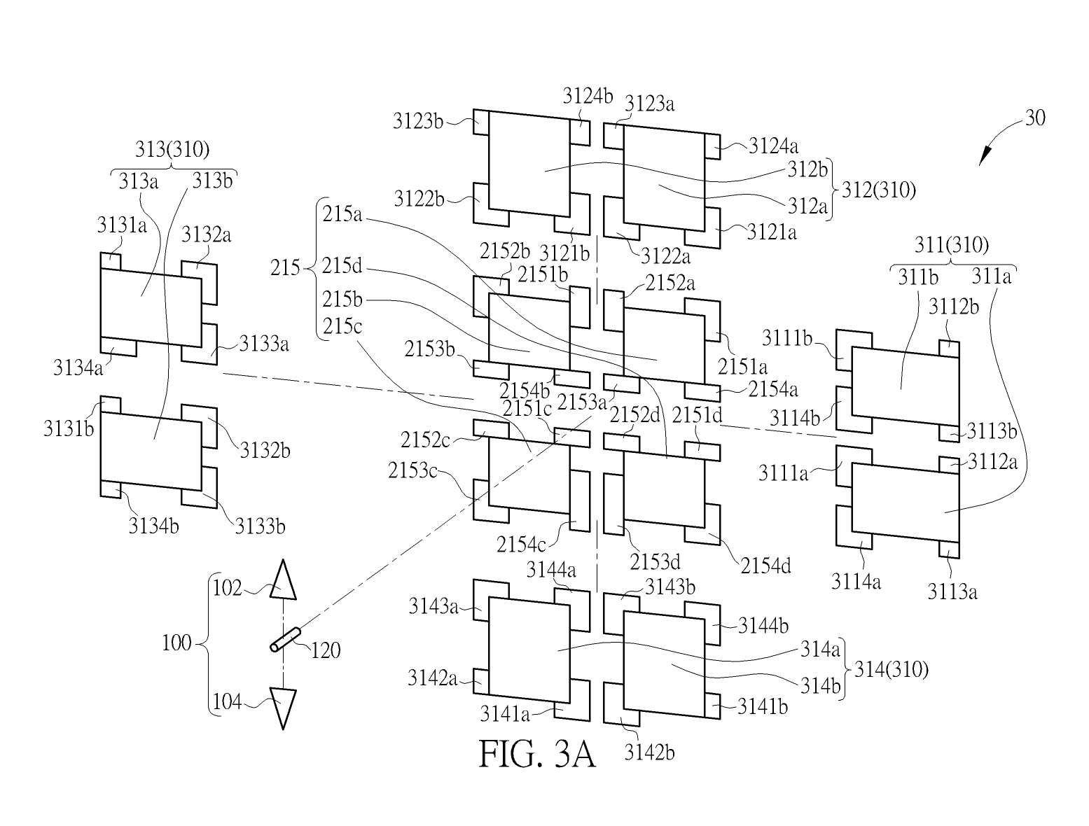

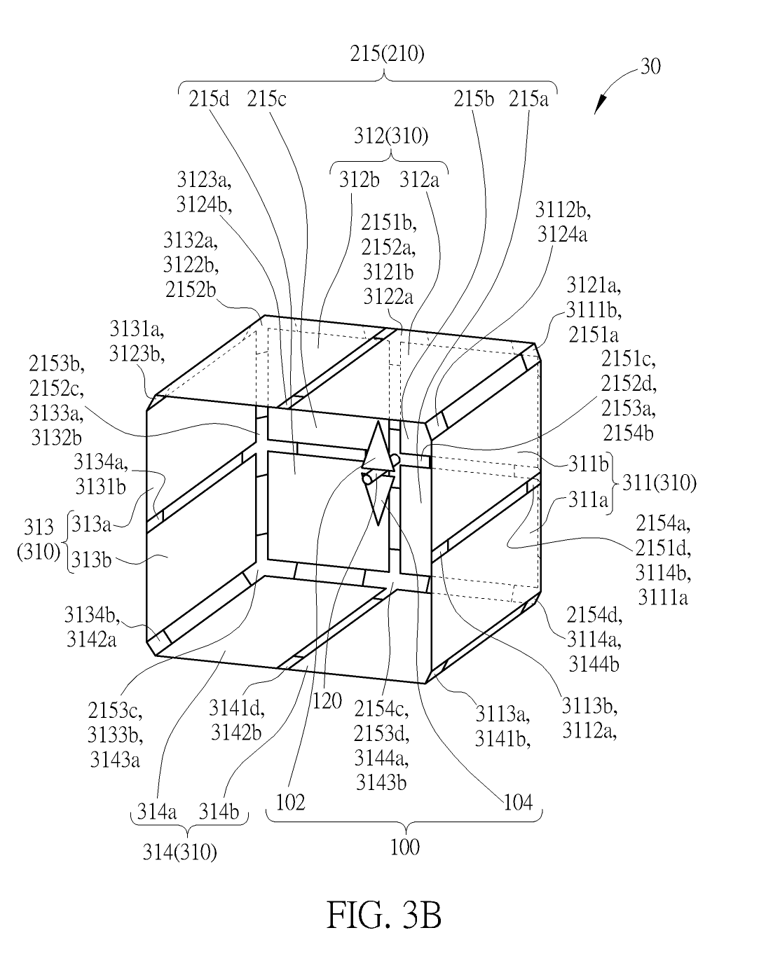

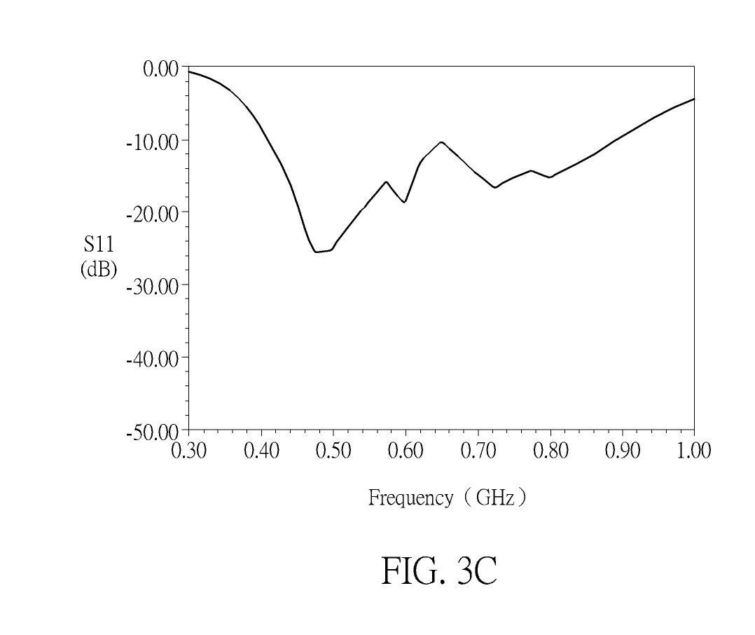

In order to further reduce the maximum area, length and width of the single plate of the disassembled broadband antenna 20, please refer to FIGS. 3A-3C. FIG. 3A is a schematic diagram illustrating an exploded view of a broadband antenna 30 according to an embodiment of the present invention. FIG. 3B is a schematic diagram illustrating a perspective view of the broadband antenna 30 after assembly. FIG. 3C is a schematic diagram illustrating antenna resonance simulation results of the broadband antenna 30. As shown in FIG. 3A, structures of the broadband antenna 30 and the broadband antenna 20 are substantially similar. However, unlike the broadband antenna 20, a metal reflective element 311 of a metal reflective module 310 of the broadband antenna 30 comprises metal reflective plates 311a and 311b, a metal reflective element 312 comprises metal reflective plates 312a and 312b, a metal reflective element 313 comprises metal reflective plates 313a and 313b, and a metal reflective element 314 comprises metal reflective plates 314a and 314b. Moreover, the metal reflective plates 311a, 311b can be assembled to form the metal reflective element 311 by fixing assembly elements 3111a and 3112a of the metal reflective plate 311a to assembly element 3114b and 3113b of the metal reflective plate 311b together. The metal reflective plates 312a and 312b can be assembled to form the metal reflective element 312 by fixing assembly element 3122a and 3123a of the metal reflective plate 312a to assembly elements 3121b and 3124b of the metal reflective plates 312b together, The metal reflective plate 313a and 313b can be assembled to form the metal reflective element 313 by fixing assembly elements 3133a and 3134a of the metal reflective plate 313a to assembly elements 3132b and 3131b of the metal reflective plate 313b together. The metal reflective plates 314a and 314b can be assembled to form the metal reflective element 314 by fixing assembly elements 3141a and 3144a of the metal reflective plate 314a to assembly elements 3142b and 3143b of the metal reflective plate 314b together. FIG. 3C shows the antenna simulation resonant results of the broadband antenna 30, wherein length and width of the assembled broadband antenna 30, are set to be 500 mm, height is set to be 163 mm, and the distance D1 between the metal reflective plates 311a-314b and 215a-215d is set to be 0.5 mm. As can be seen from FIG. 3C, the resonance bandwidth of the broadband antenna 30 covers ultra high frequency band by using −10 dB as a threshold. On the other hand, Table 3 is an antenna characteristic table for the broadband antenna 30. According to table 3, the broadband antenna 30 has a high directivity. Since the metal reflective elements 311-314 are formed from two smaller metal reflective plates assembled together, the maximum area, length and width of one single dismantled metal reflective can be minimized to facilitate storage and transportation. It is worth to note that the metal reflective elements 311-314 can be respectively formed from more pieces of the metal reflective plates to further increase convenience of storage and transportation.

TABLE 3

| | | | 3 dB | | common polarization |
|---|---|---|---|---|---|
| | maximum | | beam- | front-to-back | to cross polarization |
| frequency | gain | | width | ratio | ratio |
| 470 MHz | 8.8 | dBi | 70 deg | 17.2 dB | 40.2 dB |
| 500 MHz | 9.l | dBi | 68 deg | 17.3 dB | 47.2 dB |
| 600 MHz | 8.8 | dBi | 57 deg | 8.1 dB | 17.5 dB |
| 700 MHz | 10.7 | dBi | 53 deg | 15.8 dB | 32.4 dB |
| 800 MHz | 11.4 | dBi | 44 deg | 14.4 dB | 42.7 dB |
| 862 MHz | 12.l | dBi | 38 deg | 19.5 dB | 40.4 dB |

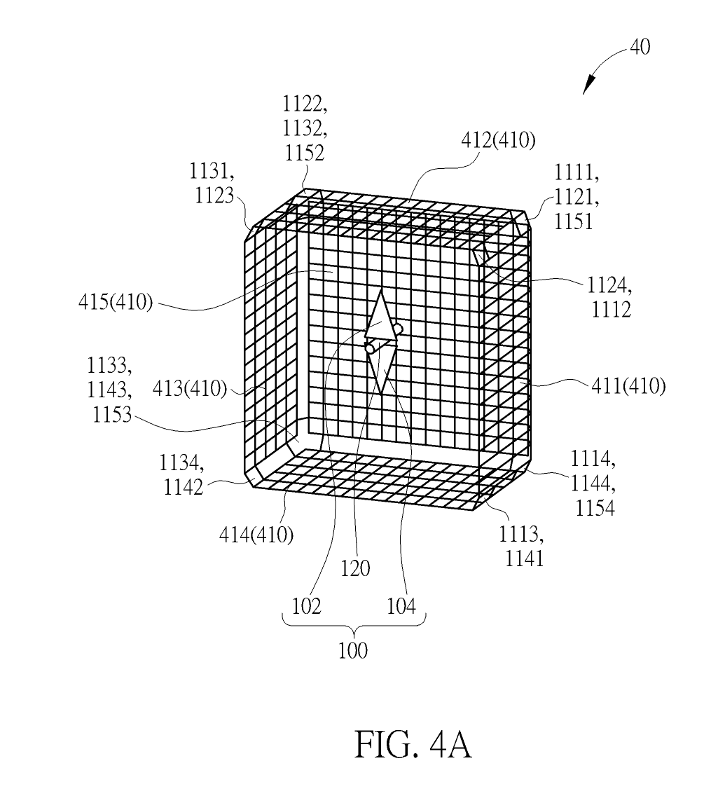

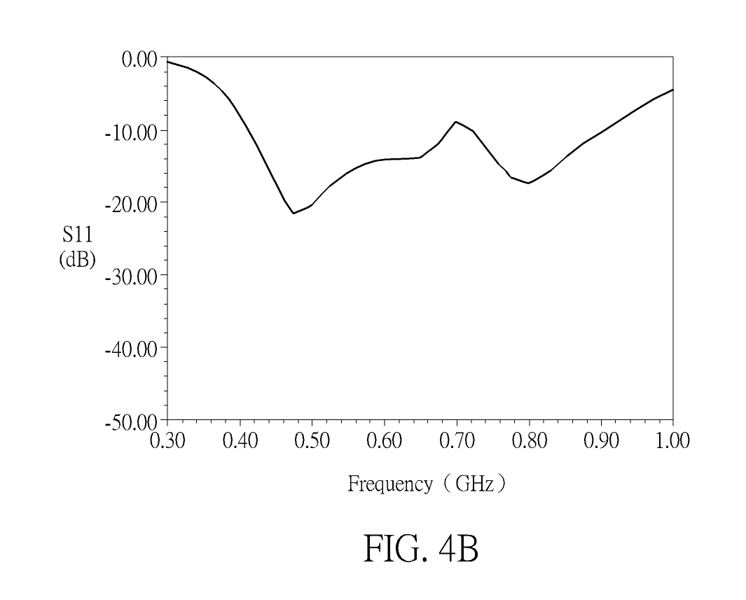

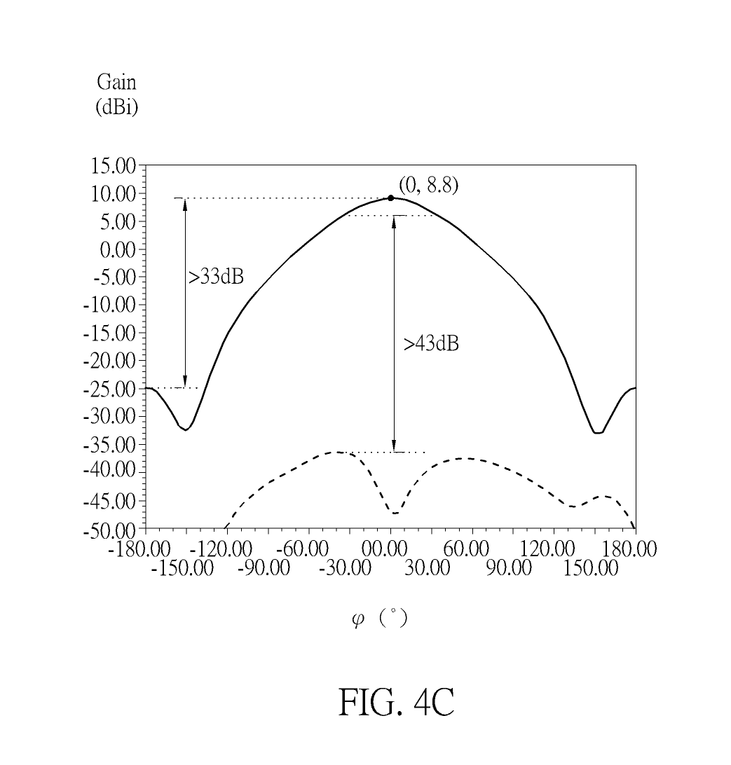

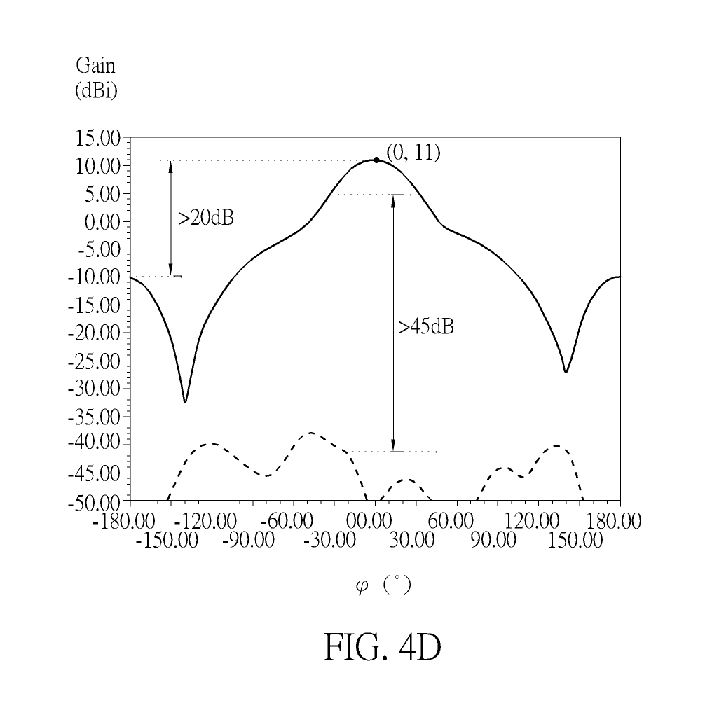

As set forth above, the metal reflective elements in the embodiment of the present invention can be formed with a plurality of metal reflective plates, and two adjacent metal reflective elements can be electrically connected by assembly elements, such that the metal reflective module can provide a cavity structure to effectively reflect wireless radio signals and to increase gain of the broadband antenna. However, when the size of the metal reflective module is enlarged, not only the gain of the broadband antenna can increase but weight of the broadband antenna or air resistance (sometimes called drag) of the broadband antenna, when installed outdoors, will also grow. Therefore, geometrical structure of the metal reflective module can be properly adjusted according to system requirements. Please refer to FIG. 4A. FIG. 4A is a schematic diagram illustrating a perspective view of the broadband antenna 40 after assembly according to an embodiment of the present invention. As shown in FIG. 4A, structures of the broadband antenna 40 and the broadband antenna 10 are substantially similar. However, metal reflective elements 411-415 of the broadband antenna 40 comprise a plurality of grids. FIG. 4B is a schematic diagram illustrating antenna resonance simulation results of the broadband antenna 40. FIG. 4C is a schematic diagram illustrating antenna gain versus radiation pattern angle relationship for the broadband antenna 40 operated at 500 MHz . FIG. 4D is a schematic diagram illustrating antenna gain versus radiation pattern angle relationship for the broadband antenna 40 operated at 800 MHz. In FIGS. 4C and 4D, length and width of the assembled broadband antenna 40 are set to be 500 mm, height is set to be 163 mm, the distance D1 between the metal reflective elements 411-415 is set to be 0.5 mm, the metal reflective elements 411-414 are respectively woven from 6 transverse metal wires and 16 longitudinal metal wires (i.e., 6 rows of metal wires woven over and under 16 columns of metal wires), and the metal reflective element 415 is woven from 16 transverse metal wires and 16 longitudinal metal wires. As can be seen from FIG. 4B, the resonance bandwidth of the broadband antenna 40 covers ultra high frequency band by using −10 dB as a threshold. On the other hand, Table 4 is an antenna characteristic for the broadband antenna 40. According to Table 4, the broadband antenna 40 has a high directivity. Since the metal reflective elements 411-415 respectively have a plurality of grids, both the weight and air resistance of the broadband antenna 40 can be further minimized.

TABLE 4

| | | 3 dB | | common polarization |
|---|---|---|---|---|
| | maximum | beam- | front-to-back | to cross polarization |
| frequency | gain | width | ratio | ratio |
| 470 MHz | 8.6 dBi | 73 deg | 31.0 dB | 44.6 dB |
| 500 MHz | 8.8 dBi | 72 deg | 33.5 dB | 43.2 dB |
| 600 MHz | 10.0 dBi | 60 deg | 35.9 dB | 41.5 dB |
| 700 MHz | 11.0 dBi | 50 deg | 18.6 dB | 48.0 dB |
| 800 MHz | 11.0 dBi | 44 deg | 20.9 dB | 45.9 dB |
| 862 MHz | 11.2 dBi | 42 deg | 21.0 dB | 34.6 dB |

In short, the metal reflective module 410 with grids is substantially composed of the metal reflective elements 411-415, which substantially have a plate-like structure respectively. Therefore, it is not only simple to manufacture but also easier for storage and transportation after dismantled. Furthermore, because there are a plurality of grids in the metal reflective elements 411-415 respectively, it can effectively minimize the weight and air resistance of the broadband antenna.

Please note that the broadband antennas 10-40 are exemplary embodiments of the present invention. Those skilled in the art can make modifications or alterations accordingly. For example, the gap G1 is related to operating frequency of the broadband antenna. In general, when the gap G1 is substantially equal to a quarter of a wavelength of wireless signals, the broadband antenna can provide a maximum gain. As long as the metal radiation portion 100 and the metal reflective module are not electrically connected to each other, the supporting element 120 can be made of isolating materials, such as wood, glass, rubber etc., but is not limited thereto. On the other hand, size of the grids within the metal reflective elements can be properly adjusted according to system requirements, and each of the metal reflective elements may have different grid sizes. As shown in FIG. 4A, the grids of the metal reflective elements 411-414 have a shape substantially conforming to a square; however, the present invention is not limited thereto, and the grids may have other shapes such as a triangle, a rectangle, a diamond, a hexagon or other proper shapes. Lengths of the metal reflective elements can be adjusted according to system requirements and thus may not be a constant. The metal reflective module is not limited to have a shape conforming to cuboid, and it maybe assembled to form a cavity structure of other shapes, for example, a sphere, a polyhedron or an irregular three-dimensional structure, which facilitates storage and transportation after the metal reflective module is properly folded or dismantled.

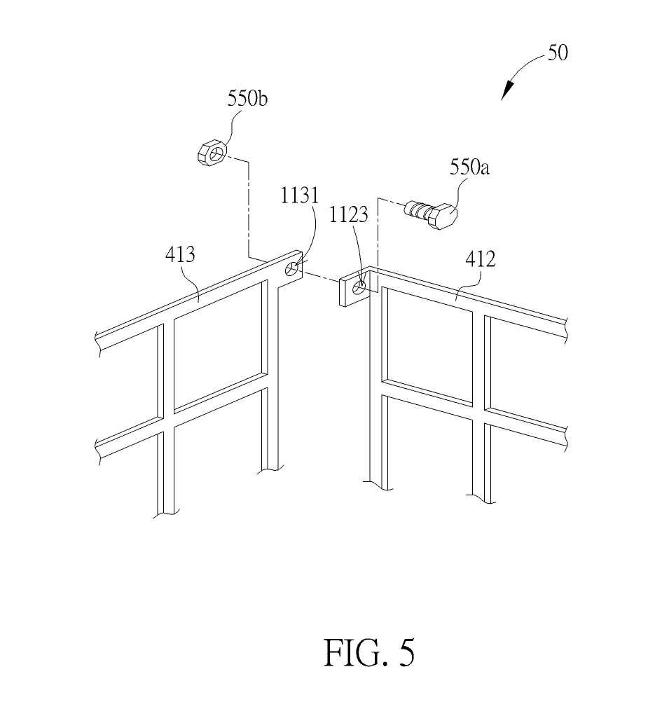

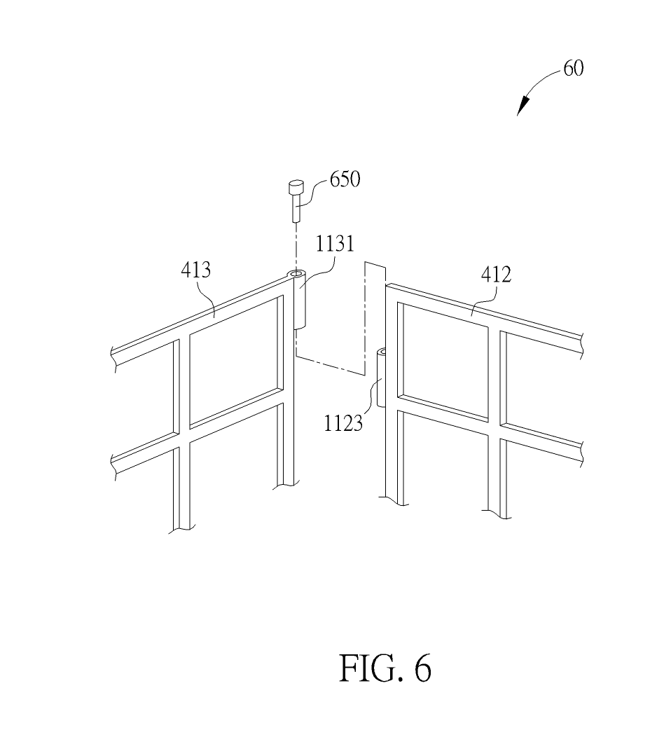

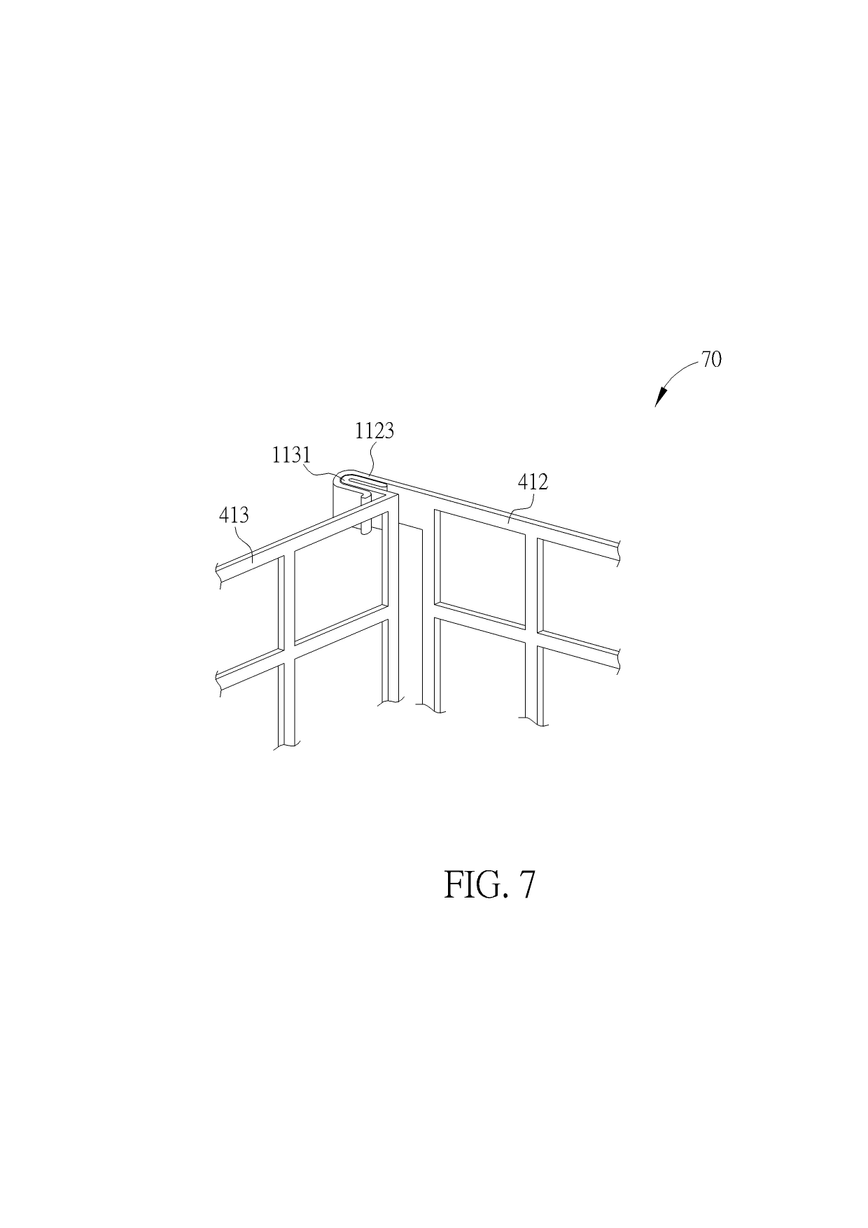

The assembly elements of the broadband antennas can be electrically connected by soldering; for example, the metal reflective element 215 can be formed by soldering the metal reflective plates 215a-215d shown in FIGS. 2A-2C. However, according to ways to dismantle or fold the metal reflective module, fixation of the supporting element and the metal reflective module as well as structure of the assembly element can be properly designed. For example, please refer to FIG. 5. FIG. 5 is a schematic diagram illustrating a locally enlarged view of a broadband antenna 50 according to an embodiment of the present invention. Structures of the broadband antenna 50 and the broadband antenna 40 are substantially similar. In the broadband antenna 50, the assembly elements (e.g., the assembly elements 1131, 1123) at the adjacent vertices of the metal reflective elements may have an opening respectively, and can be fixed with corresponding locking elements (e.g., locking elements 550a, 550b) of the assembly elements, such that the metal reflective module can be assembled to form a cavity structure, electrical connection among the metal reflective elements can be ensured, and the broadband antenna 50 may be dismantled for easier storage or transportation. Please note that the locking elements (e.g., the locking element 550b) can be fixed to the corresponding assembly elements (e.g., the assembly element 1131) of the metal reflective elements (e.g., the metal reflective element 413), and, alternatively, the locking elements (e.g., 550a) can be semi-fixed to the corresponding assembly elements (e.g., 1123) of the metal reflective elements (e.g., 412) to ensure relative rotation. Besides, please refer to FIG. 6. FIG. 6 is a schematic diagram illustrating a locally enlarged view of a broadband antenna 60 according to an embodiment of the present invention. Structures of the broadband antenna 60 and the broadband antenna 40 are substantially similar. In the broadband antenna 60, the assembly elements (e.g., 1131, 1123) at the adjacent vertices of the metal reflective elements may have a shaft hole respectively, and can be fixed with corresponding shaft elements (e.g., a shaft element 650) of the assembly elements serving as a pivot, such that the metal reflective module can be assembled to form a cavity structure, electrical connection among the metal reflective elements can be ensured, and the broadband antenna 60 may be dismantled for easier storage or transportation. Please note that the shaft elements (e.g., the shaft element 650) can be semi-fixed to the corresponding assembly elements (e.g., 1131) of the metal reflective elements (e.g., 413) or assembly elements (e.g., 1123) of metal reflective elements (e.g. 412) to ensure relative rotation. Please refer to FIG. 7. FIG. 7 is a schematic diagram illustrating a locally enlarged view of a broadband antenna 70 according to an embodiment of the present invention. Structures of the broadband antenna 70 and the broadband antenna 40 are substantially similar. In the broadband antenna 70, the assembly elements (e.g., 1131, 1123) at the adjacent vertices of the metal reflective elements may respectively be a sliding slot and a sliding pin structure with sizes corresponding to each other. In this case, the sliding pin structure can be pushed onto the sliding slot to lock metal reflective elements, such that the metal reflective module can be assembled to form a cavity structure, electrical connection among the metal reflective elements can be ensured, and the broadband antenna 70 may be dismantled for easier storage or transportation.

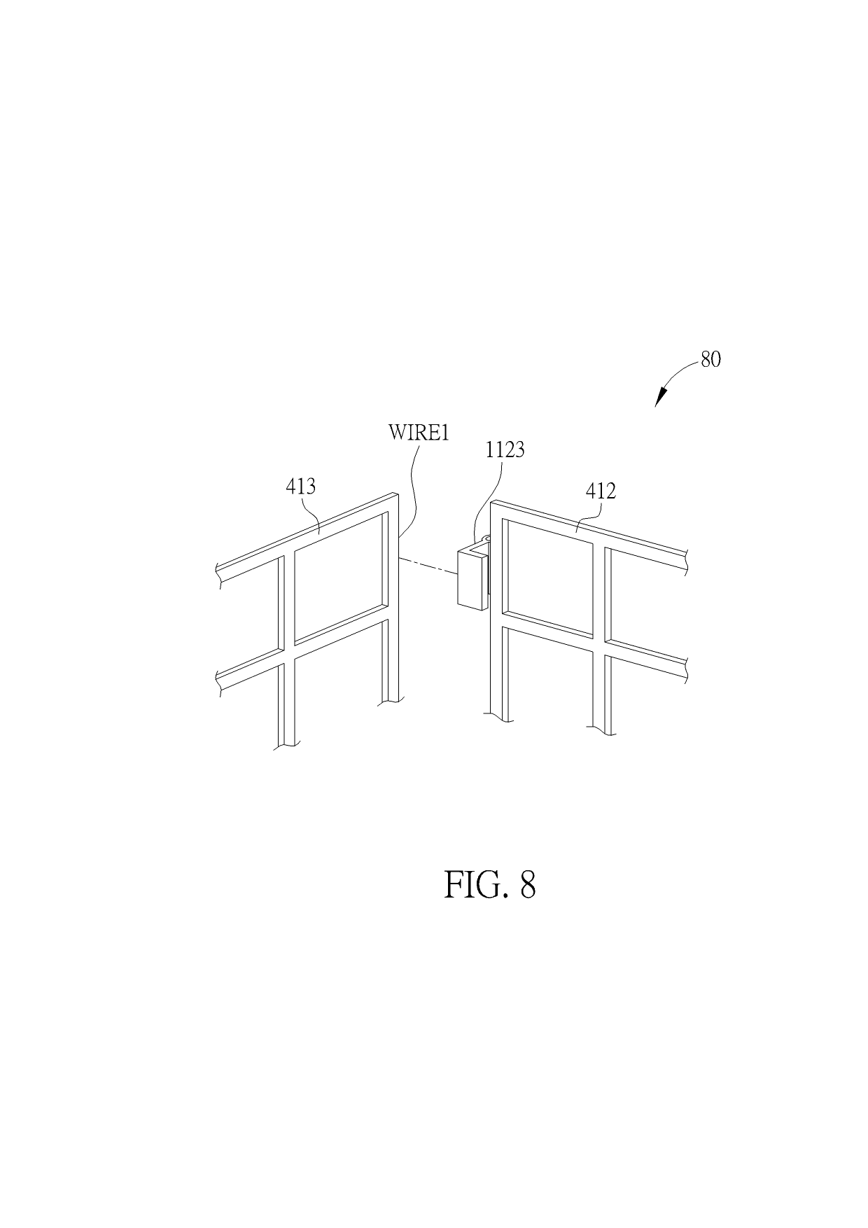

In addition, the assembly elements 1111-3144b of the broadband antennas 10-70 are exemplary embodiments of the present invention, but the present invention is not limited thereto and may be adjusted by adding or reducing the number of the assembly elements according to different design requirements such as the structure of the assembly elements. Please refer to FIG. 8. FIG. 8 is a schematic diagram illustrating a locally enlarged view of a broadband antenna 80 according to an embodiment of the present invention. Structures of the broadband antenna 80 and the broadband antenna 40 are substantially similar. In the broadband antenna 80, the assembly elements (e.g. , 1123) of the metal reflective elements may be a hook, and can be fixed to a longitudinal metal wire (e.g., WIRE1) at the edge of the adjacent vertex, such that the metal reflective module can be assembled to form a cavity structure, electrical connection among the metal reflective elements can be ensured, and the broadband antenna 80 may be dismantled for easier storage or transportation. In other words, assembly elements may be disposed merely around a portion of the vertices of the metal reflective elements (e.g. , 413), while no assembly element is provided around the other vertices (e.g., the vertex around the longitudinal metal wire WIRE1) of the metal reflective elements (i.e., 413). In such a situation, an assembly element (e.g. , 1123) is fixed to the corresponding vertex (e.g., the vertex around the longitudinal metal wire WIRE1) of the adjacent metal reflective elements without an assembly element so as to assemble the metal reflective module to form a cavity structure.

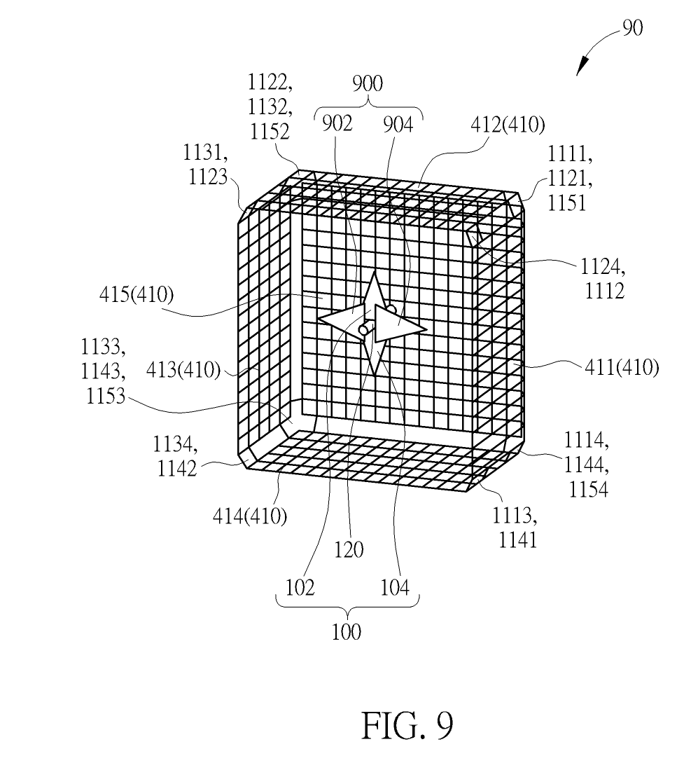

On the other hand, the broadband antenna of the present invention may be a broadband dual polarization antenna. Please refer to FIG. 9. FIG. 9 is a schematic diagram illustrating a broadband antenna 90 according to an embodiment of the present invention. Structures of the broadband antenna 90 and the broadband antenna 40 are substantially similar. Unlike the broadband antenna 40, the broadband antenna 90 further comprises a metal radiation portion 900 disposed on the metal radiation portion 100. The supporting element 120 separates the metal radiation portion 900 from the metal radiation portion 100 by a gap so that the metal radiation portion 900 is electrically isolated from the metal radiation portion 100 to enhance isolation of the metal radiation portions 100 and 900. The metal radiation portion 900 comprises triangular metal plates 902 and 904. The base of the triangular metal plate 102 is in parallel to the base of the triangular metal plate 104, forming the metal radiation portion 900 into a rhombus. A midline of the metal radiation portion 100 is substantially perpendicular to a midline of the metal radiation portion 900.

Please note that the metal radiation portions 100 and 900 of the broadband antenna 90 shown in FIG. 9 are parallel to each other, but not limited hereto. The metal radiation portion 900 of the broadband antenna 90 of the embodiment of the present invention can be leaned out from the supporting element 120 upwardly. Alternatively, the metal radiation portion 100 can be leaned out from the central supporting element 120 toward the metal reflective element 415. In other words, the metal radiation portion 100 of the present invention may not be completely parallel to the metal radiation portion 900. On the other hand, the metal radiation portion 100 of present invention of the broadband antenna 90 can be bent upward with a specific curvature to lower down radiation pattern, thereby balancing the radiation pattern. Alternatively, the metal radiation portion 900 of the broadband antenna 90 of the embodiment of the present invention can be bent toward the metal reflective element 415 with a specific curvature in order to shorten the distance between the metal radiation portion 900 and the metal reflective element 415, thereby rising radiation pattern of the metal radiation portion 900.

In summary, the triangular metal plates of the metal radiation portions in the embodiment of the present invention increase bandwidth. After assembly, the metal radiation portion is enveloped by the metal reflective module of a cavity structure to effectively reflect wireless signals and to enhance the gain of the broadband antenna. After dismantling, the elements of the broadband antenna can be accommodated separately. Because the metal reflective module is substantially composed of the metal reflective elements of a plate-like structure, it is simple to manufacture and easier for storage and transportation. Besides, the metal reflective elements may have a plurality of grids respectively to minimize both weight and air resistance of the broadband antenna.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A broadband antenna, configured to receive and transmit at least one wireless signal, comprising:
a first metal radiation portion comprising a first triangular metal plate and a second triangular metal plate;
a metal reflective module comprising a plurality of metal reflective elements, wherein the plurality of metal reflective elements are able to be assembled to make the metal reflective module a shape substantially conforming to a cavity structure and to surround the first metal radiation portion, and the metal reflective module is configured to reflect the at least one wireless signal and to enhance gain of the broadband antenna; and
a supporting element, configured to fix the first triangular metal plate in opposition to the second triangular metal plate, to attach the first metal radiation portion to the cavity structure of the metal reflective module, and to electrically isolate the metal reflective module from the first metal radiation portion.

2. The broadband antenna of claim 1, wherein the metal reflective module comprises:
a first metal reflective element having a shape substantially conforming to a rectangle, wherein at least one assembly element is disposed at a first vertex, a second vertex, a third vertex or a fourth vertex of the first metal reflective element;
a second metal reflective element having a shape substantially conforming to a rectangle, wherein at least one assembly element is disposed at a first vertex, a second vertex, a third vertex or a fourth vertex of the second metal reflective element;
a third metal reflective element having a shape substantially conforming to a rectangle, wherein at least one assembly element is disposed at a first vertex, a second vertex, a third vertex or a fourth vertex of the third metal reflective element;
a fourth metal reflective element having a shape substantially conforming to a rectangle, wherein at least one assembly element is disposed at a first vertex, a second vertex, a third vertex or a fourth vertex of the fourth metal reflective element; and
a fifth metal reflective element having a shape substantially conforming to a rectangle, wherein at least one assembly element is disposed at a first vertex, a second vertex, a third vertex or a fourth vertex of the fifth metal reflective element;
wherein the at least one assembly element is configured to connect the first metal reflective element, the second metal reflective element, the third metal reflective element, the fourth metal reflective element and the fifth metal reflective element to form the cavity structure or to detach the cavity structure of the metal reflective module.

3. The broadband antenna of claim 2, wherein the at least one assembly element is selected from a group comprising a screw, a nut, a hole, a shaft, a sliding slot, a sliding pin structure, and a hook.

4. The broadband antenna of claim 1, wherein the first metal reflective element comprises a plurality of first grids, the second metal reflective element comprises a plurality of second grids, the third metal reflective element comprises a plurality of third grids, the fourth metal reflective element comprises a plurality of fourth grids, and the fifth metal reflective element comprises a plurality of fifth grids.

5. The broadband antenna of claim 4, wherein shapes and sizes of the plurality of first grids, the plurality of second grids, the plurality of third grids, the plurality of fourth grids and the plurality of fifth grids are the same.

6. The broadband antenna of claim 2, wherein the fifth metal reflective element has a shape substantially conforming to a square, and the first metal reflective element, the second metal reflective element, the third metal reflective element and the fourth metal reflective element have a shape substantially conforming to a rectangle.

7. The broadband antenna of claim 1, wherein the first triangular metal plate and the second triangular metal plate are isosceles triangles.

8. The broadband antenna of claim 1, wherein the broadband antenna further comprises a second metal radiation portion disposed above the first metal radiation portion, and separated from the first metal radiation portion by a gap.

9. The broadband antenna of claim 2, wherein the first metal reflective element, the second metal reflective element, the third metal reflective element, the fourth metal reflective element or the fifth metal reflective element comprises a plurality of metal reflective plates, wherein at least one assembly element is disposed at a first vertex, a second vertex, a third vertex or a fourth vertex of at least one of the plurality of metal reflective plates, and wherein the at least one assembly element is configured to connect the plurality of metal reflective plates to form the first metal reflective element, the second metal reflective element, the third metal reflective element, the fourth metal reflective element or the fifth metal reflective element, to connect the first metal reflective element, the second metal reflective element, the third metal reflective element, the fourth metal reflective element and the fifth metal reflective element to form the cavity structure, to detach the cavity structure of the metal reflective module, or to detach the first metal reflective element, the second metal reflective element, the third metal reflective element, the fourth metal reflective element or the fifth metal reflective element.

10. The broadband antenna of claim 9, wherein at least one assembly element is disposed on a side of the first metal reflective element, the second metal reflective element, the third metal reflective element, the fourth metal reflective element or the fifth metal reflective element to correspond to the at least one assembly element of the plurality of the metal reflective plates.

11. The broadband antenna of claim 2, wherein the at least one assembly element at the first vertex of the first metal reflective element, the at least one assembly element at the first vertex of the second metal reflective element and the at least one assembly element at the first vertex of the fifth metal reflective element are correspondingly disposed, wherein the at least one assembly element at the second vertex of the second metal reflective element, the at least one assembly element at the second vertex of the third metal reflective element and the at least one assembly element at the second vertex of the fifth metal reflective element are correspondingly disposed, wherein the at least one assembly element at the third vertex of the third metal reflective element, the at least one assembly element at the third vertex of the fourth metal reflective element and the at least one assembly element at the third vertex of the fifth metal reflective element are correspondingly disposed, wherein the at least one assembly element at the fourth vertex of the fourth metal reflective element, the at least one assembly element at the fourth vertex of the fifth metal reflective element and the at least one assembly element at the fourth vertex of the first metal reflective element are correspondingly disposed, wherein the at least one assembly element at the second vertex of the first metal reflective element is disposed corresponding to the at least one assembly element at the fourth vertex of the second metal reflective element, wherein the at least one assembly element at the third vertex of the second metal reflective element is disposed corresponding to the at least one assembly element at the first vertex of the third metal reflective, wherein the at least one assembly element at the fourth vertex of the third metal reflective element is disposed corresponding to the at least one assembly element at the second vertex of the fourth metal reflective element, and wherein the at least one assembly element at the first vertex of the fourth metal reflective element is disposed corresponding to the at least one assembly element at the third vertex of the first metal reflective element.
